(19) United States
(12) Patent Application Publication
(10) Pub. No.: US 2021/0065311 A1
(43) Pub. Date: Mar. 4, 2021

(54) Systems and Methods for Register Verification

(71) Applicant: Vero Technologies, Inc., Greenwich, CT (US)

(72) Inventors: Louis H. Baugier, Greenwich, CT (US); Valentin Degrange, New York, NY (US); Kevin Clark, West Orange, NJ (US); John Descalzi, Westfield, NJ (US)

(21) Appl. No.: 16/998,534

(22) Filed: Aug. 20, 2020

Related U.S. Application Data
(60) Provisional application No. 62/892,865, filed on Aug. 28, 2019.

(51) Int. Cl. G06Q 40/00

(52) U.S. Cl. CPC G06Q 40/125

(57) ABSTRACT

Embodiments provide systems and methods for verifying financial records to facilitate, for example, residential leasing decisions. Financial information from a user's bank account is collected and compared with user provided information to determine the veracity of the user provided information to improve the speed, consistency, and accuracy of residential leasing decisions. Financial information can be used to verify stated income as well as verify past rental or mortgage payments.

### CROSS REFERENCE TO RELATED APPLICATIONS

This application claims the benefit of priority of U.S. Provisional Patent Application Ser. No. 62/892,865, filed on Aug. 28, 2019, the entire contents of which are hereby incorporated by reference herein.

### TECHNOLOGY FIELD

The present application relates to systems and methods that can be used to accurately verify financial information of an individual as part of a business transaction.

### BACKGROUND

One of the important elements in any business transaction is the ability of the buyer to pay for goods or services. In “all-cash deals,” a buyer pays the seller in cash for a good or service. In such a transaction, the seller is assured that the buyer can pay because the buyer gives the seller the desired amount of money. However, most transactions do not involve cash, and instead involve credit to the buyer based on a determination that the buyer has the ability to pay. For example, a credit card company extends credit based on its determination that the credit card recipient will be able to pay for the charges on the card.

The ability to determine whether a party is a good credit risk (i.e., likely to be able to pay for the purchased goods or services) becomes even more important when the business transaction involves timely payments (e.g., monthly payments). For example, a long-term loan requires regular timely payments, and the financial success of a lender is predicated on accurately determining the credit risk of the potential recipient of the loan (“borrower”). To determine the credit risk for a loan, a lender needs to have accurate financial information about the borrower. Conventionally, this information may include one or more credit reports that provide a score indicating the creditworthiness of the borrower, paycheck information, bank account balances, and other sources of income or wealth.

In particular, in residential leasing, for example, the ability to verify a potential tenant's financial information such as income and rental payment history is important because such information not only indicates whether the potential tenant can and will pay the rent on time, but it is also an indicator of whether a potential tenant will be a good tenant or not. To protect their residential real estate assets from rent delinquency, misbehavior, and eviction, landlords and property managers assert screening processes to establish a profile on an applicant before allowing them to take residency. These profiles include applicant credit, background, eviction information in addition to previous residential information, employment, and financial information. This information is used to determine the likelihood of whether the prospective tenant will be a good tenant or not.

Residential landlords, property managers, or brokers may ask a rental applicant to demonstrate their financial viability to effectuate a leasing decision. Prospective renters may furnish third-party documents like employment letters, monthly bank statements, W2 tax documents, and pay stubs, and the like to prove they have and will likely maintain sufficient income and/or assets (e.g., cash balance) to afford the rent for the duration of the lease.

Upon receiving these financial documents, leasing stakeholders may choose to verify the information. The verification process conventionally involves calling employers, reviewing the legitimacy of documentation, ensuring the materials are sufficiently informative, etc. to enable a stakeholder to ultimately make a leasing decision.

When an applicant successfully provides adequate information on income or assets, leasing decision-makers gain the visibility required to either approve, conditionally approve, or deny a prospective renter.

The conventional process is slow, subject to fraud, and not narrowly tailored. The speed of the conventional process costs landlords money and time in trying to validate applicant-submitted documents and renting units. In addition, landlords suffer because the information submitted by applicants is subject to fraud, such as by digital editing of documents to show employment or a higher income.

The conventional process also is deficient for prospective tenants (“applicants”). The slow application approval process leaves applicants waiting. Prospective tenants also have a greater security risk in conventional systems because their financial information must be transmitted, often in paper form or by email, to landlords for review. Such sensitive documents, with personally identifiable information, can be the source of identity theft or financial hardships if they fall into the wrong hands. Another problem with the conventional application process for prospective tenants is that tenants are often forced to share more financial information than necessary when they provide bank statements. For example, a bank statement may have a list of monthly transactions that an applicant does not wish to share with a potential landlord, but short of redacting all the undesired information, there is no easy way to provide only the required financial information.

### BRIEF DESCRIPTION OF THE DRAWINGS

FIG. 1 is a block diagram of an environment with an example of a financial verification computing apparatus that verifies financial information from a financial institution;

FIG. 2 is a block diagram of the example of the financial verification computing apparatus shown in FIG. 1;

FIG. 3 is a flow chart of an example of a method for income verification using financial information from a financial institution;

FIG. 4 is a flow chart of an example of a method for determining an income stream;

FIG. 5 is a diagram of an exemplary user interface for initiating an income verification;

FIG. 6 is a diagram of an exemplary user interface for selecting a financial institution;

FIG. 7 is a diagram of an exemplary user interface for a selected financial institution;

FIG. 8 is a diagram of an exemplary user interface for entering employment history information;

FIG. 9 is a diagram of an exemplary user interface of an employment, income, and asset verification notice;

FIG. 10 is a diagram of an exemplary user interface showing verified employment, income, and asset information, which is provided to the user;

FIG. 11 is a diagram of an exemplary user interface showing verified employment, income, and asset information, which is provided to a third party;

FIG. 12 is a block diagram of an example of a method for payment verification using financial information from a financial institution; and

FIG. 13 is a block diagram of an example of a method for determining payment information.

### DETAILED DESCRIPTION OF ILLUSTRATIVE EMBODIMENTS

The present description and claims may make use of the terms “a,” “at least one of,” and “one or more of,” with regard to particular features and elements of the illustrative embodiments. It should be appreciated that these terms and phrases are intended to state that there is at least one of the particular features or elements present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

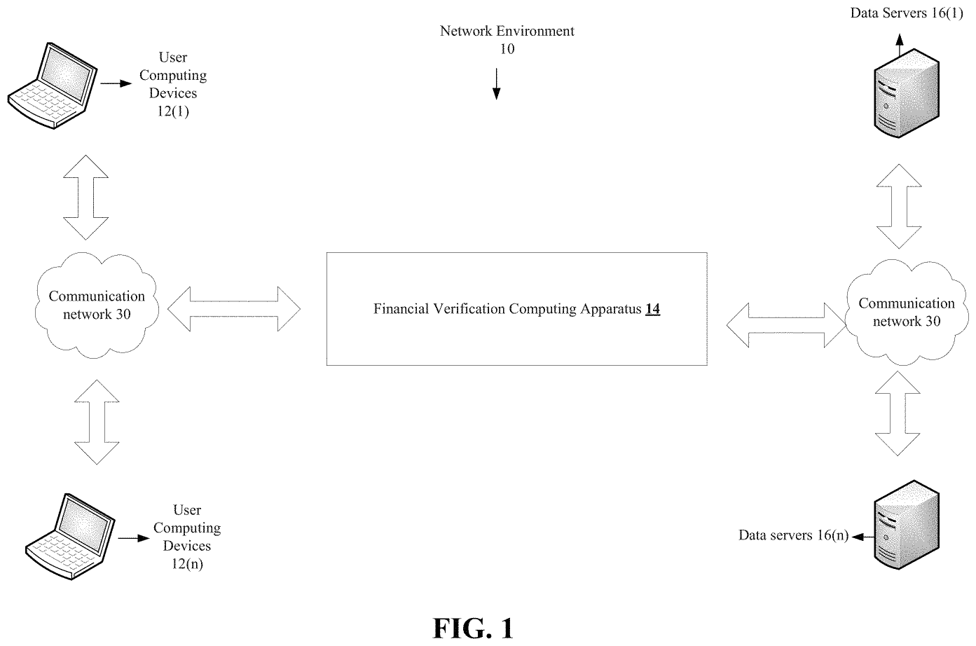

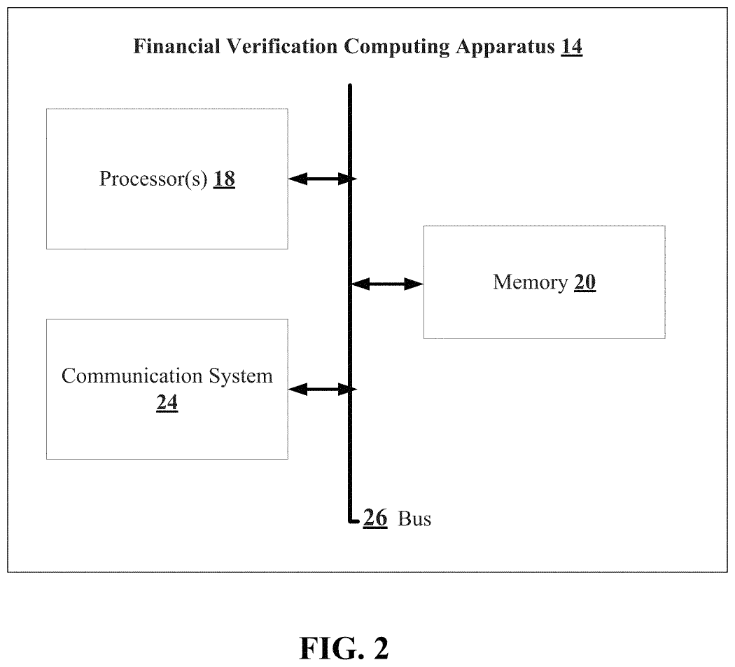

A network environment 10 with an example of a financial verification computing apparatus 14 is illustrated in FIGS. 1-2. In this particular example, the network environment 10 includes the financial verification computing apparatus 14, one or more user computing devices 12(1)-12(n), one or more data servers 16(1)-16(n) coupled via one or more communication networks 30, although the environment could include other types and numbers of systems, devices, components, and/or other elements as is generally known in the art and will not be illustrated or described herein. This technology provides a number of advantages including providing methods, non-transitory computer readable media, and apparatuses that provide financial verification.

Referring more specifically to FIGS. 1-2, the financial verification computing apparatus 14 is programmed to provide income verification and payment verification, although the apparatus can perform other types and/or numbers of functions or other operations and this technology can be utilized with other types of claims. In this particular example, the financial verification computing apparatus 14 includes a processor 18, a memory 20, and a communication system 24 which are coupled together by a bus 26, although the financial verification computing apparatus 14 may comprise other types and/or numbers of physical and/or virtual systems, devices, components, and/or other elements in other configurations.

The processor 18 in the financial verification computing apparatus 14 may execute one or more programmed instructions stored in the memory 20 for verifying income and payment information as illustrated and described in the examples herein, although other types and numbers of functions and/or other operations can be performed. The processor 18 in the financial verification computing apparatus 14 may include one or more central processing units and/or general purpose processors with one or more processing cores, for example.

The memory 20 in the financial verification computing apparatus 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20. Computer readable storage, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Python, Java™, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including LAN or WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The communication system 24 in the financial verification computing apparatus 14 operatively couples and communicates between one or more of the user computing devices 12(1)-12(n) and one or more of the plurality of data servers 16(1)-16(n), which are all coupled together by one or more of the communication networks 30, although other types and numbers of communication networks or systems with other types and numbers of connections and configurations to other devices and elements may be utilized. By way of example only, the communication networks 30 can use TCP/IP over Ethernet and industry-standard protocols, including NFS, CIFS, SOAP, XML, LDAP, SCSI, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

In this particular example, each of the one or more user computing devices 12(1)-12(n) may submit requests for financial verification by the financial verification computing apparatus 14, although the requests for financial verification can be obtained by the financial verification computing apparatus 14 in other manners and/or from other sources. Each of the one or more user computing devices 12(1)-12(n) may include a processor, a memory, user input device, such as a keyboard, mouse, and/or interactive display screen by way of example only, a display device, and a communication interface, which are coupled together by a bus or other link, although each may have other types and/or numbers of other systems, devices, components, and/or other elements.

The one or more data servers 16(1)-16(n) may store and provide data associated with financial information, by way of example only, to the financial verification computing apparatus 14 via one or more of the communication networks 30, for example, although other types and/or numbers of storage media in other configurations could be used. In this particular example, each of the one or more data servers 16(1)-16(n) may comprise various combinations and types of storage hardware and/or software and represent a system with multiple network server devices in a data storage pool, which may include internal or external networks. Various network processing applications, such as CIFS applications, NFS applications, HTTP Web Network server device applications, and/or FTP applications, may be operating on the plurality of data servers 16(1)-16(n) and may transmit data in response to requests from the financial verification computing apparatus 14. Each the one or more data servers 16(1)-16(n) may include a processor, a memory, and a communication interface, which are coupled together by a bus or other link, although each may have other types and/or numbers of other systems, devices, components, and/or other elements.

Although the exemplary network environment 10 with the financial verification computing apparatus 14, the one or more user computing devices 12(1)-12(n), the one or more data servers 16(1)-16(n), and the communication networks 30 are described and illustrated herein, other types and numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication, also can be implemented, as desired, to increase the robustness and performance of the devices, apparatuses, and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

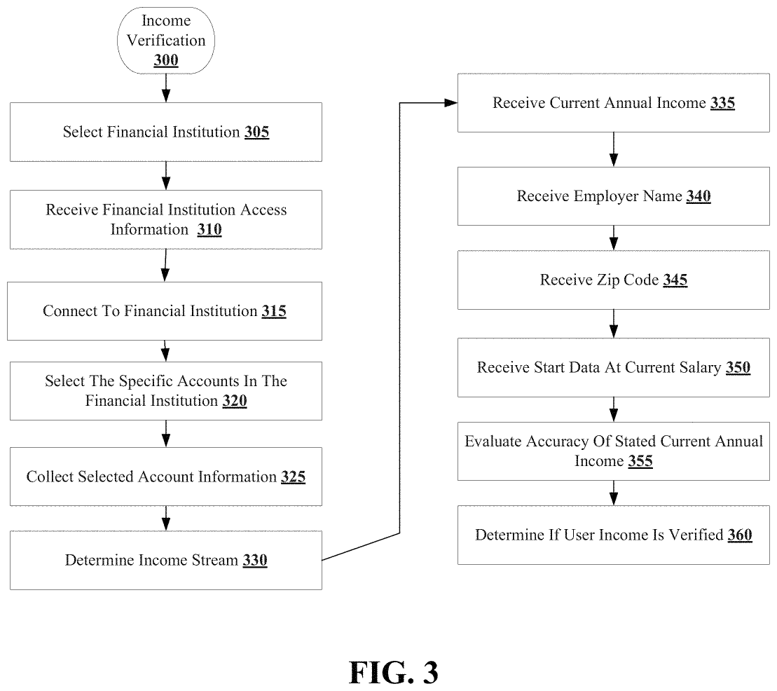

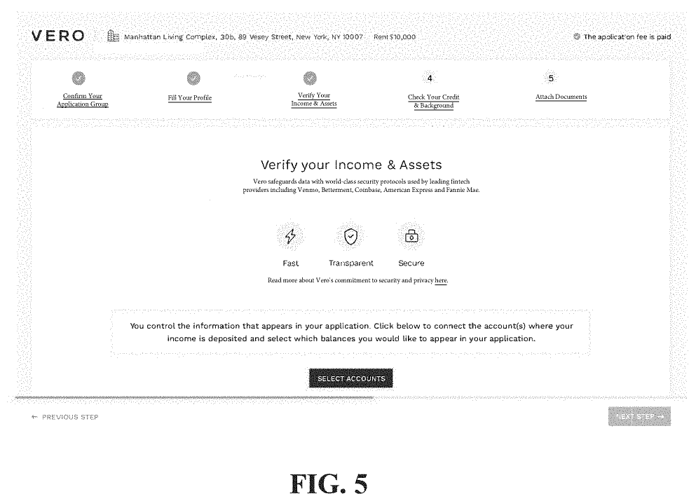

FIG. 3 discloses an exemplary method for income verification 300. The exemplary method begins at step 300, where the financial verification computing apparatus 14 may interact with one or more user computing devices 12(1)-12(n) requesting income verification. In this example, a user accessing one or more user computing devices 12(1)-12(n) initiates a request to verify the user's income. In an embodiment, the user could be a prospective tenant (also referred to as an applicant or leasee) who is applying to rent an apartment. The invention is not limited to residential leasing and could be used in any instance in which income verification would be beneficial. In another embodiment, the initiation request may originate from a party other than the party whose income needs to be verified. For example, a leasing manager may initiate the request for income verification, wherein the applicant is then subsequently contacted to verify the applicant's income as set forth below. FIG. 5 is a diagram of an exemplary user interface for initiating an income verification.

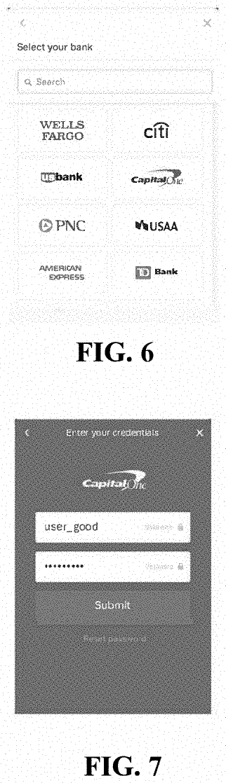

Returning to FIG. 3, in step 305, the financial verification computing apparatus 14 processes the received request to verify income. As part of this process, the financial verification computing apparatus 14 sends, to the one or more user computing devices 12(1)-12(n) used by the user whose income needs verification, a selection request to select a financial institution in which the income is deposited. FIG. 6 is a diagram of an exemplary user interface for selecting a financial institution. For example, referring to FIG. 7, a bank such as Capital One® may be selected. FIG. 6 and 7 are exemplary diagrams of the screen viewed by the user on the one or more user computing devices 12(1)-12(n).

In step 310, the user is asked to enter the appropriate access information for the selected financial institution. For example, user identification and password may be needed to access the user's accounts at the financial institution. In some embodiments, the access information may comprise biometric data associated with the user, challenge questions with answers associated with the user, personal identification numbers (PINs), or other user access information that is needed to access the user's accounts at the selected financial institution.

In step 315, the financial verification computing apparatus communicating through communication network 30 connects to the selected financial institutions and uses the financial institution access information from the user to access the user's accounts. The financial institution may store account information on one or more data servers 16(1)-16(n). If the account information is correct, the financial verification computing apparatus 14 will now have access to the user's account(s) on the selected financial institution. If the account information is incorrect, the financial verification computing apparatus 14 sends a message to the one or more user computing devices 12(1)-12(n), indicating that access to the financial institution failed. In an embodiment, the user is prompted to re-enter the user access information.

In an embodiment, the connection to the user's selected financial institution may be performed using Plaid. Plaid is an infrastructure layer that allows users to directly connect to their bank accounts. In other embodiments, the connection to the user's selected financial institution can be performed using any provider that gives access to financial transactions for the user.

The financial verification computing apparatus 14 aggregates the user's financial accounts at the financial institution and the financial verification computing apparatus 14 presents the list of financial accounts to the user at the one or more user computing devices 12(1)-12(n). For example, a list of user accounts (e.g., checking account, saving account, Certificate of Deposit (CD) account, etc.) at a financial institution can be shown in a list, from which the user can select.

At step 320, the user selects the one or more accounts that receive the user's income. For example, the user may receive direct deposit from an employer into one or more bank accounts, and the user can select those accounts to verify income. In another example, the user may deposit a paycheck into one or more accounts, and the user can select those accounts. In another example, the user may receive income from more than one source, and in such a case, the user may want to have only one source of income verified. In such a case, the user would select only the bank account that received the income the user wanted to be verified.

In step 325, the selected account information is received through the one or more user computing devices 12(1)-12(n) used by the user and communicated through the communication network 30 to financial verification computing apparatus 14. The financial verification computing apparatus 14 sends a request to the user's financial institution via communication network 30 to retrieve transaction data associated with the one or more selected accounts. The financial institution obtains this information from one or more data servers 16(1)-16(n) and provides this information to the financial verification computing apparatus 14.

The transaction data comprises the deposits, withdrawals, fees, interests, comments, transaction location, and other transactions associated with the selected account as well as account holder name(s) and associated information, account type(s), and other related account information. This transaction data comprises financial information about the user, including, in an embodiment, income information.

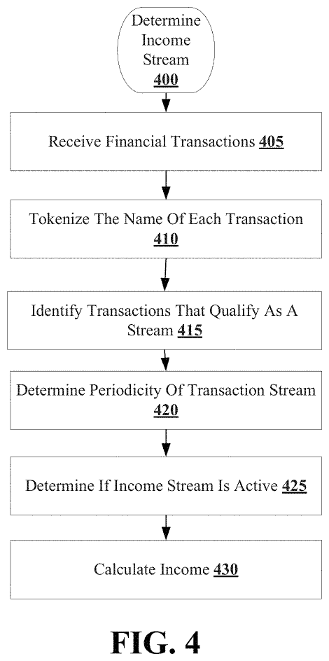

In step 330, an income stream is determined by the financial verification computing apparatus 14 from the transaction data. This process is explained in more detail with respect to FIG. 4.

The process of determining an income stream from the transaction data begins at step 400. At step 405, the transaction data from each selected account are received by the financial verification computing apparatus 14. In an embodiment, the transaction data may be limited, such as by date range or other limitations. In an embodiment, the transaction data comprises unstructured data.

At step 410, the name or description of each transaction undergoes natural language processing (NLP), which includes the tokenization of each text string describing each transaction in the transaction data. Tokenization is the process of splitting a text string into tokens so that the text string can be processed and analyzed by the financial verification computing apparatus 14. For example, the transaction description “Vero Payroll 123” can be split into tokens “Vero,” “Payroll,” and “123.” In an embodiment, the financial verification computing apparatus 14 can remove irrelevant tokens (such as a list of numbers, special characters without a definite meaning) from the analysis. For example, the financial verification computing apparatus 14 can identify the token “123” being irrelevant to analysis, and thus only the tokens “Vero” and “Payroll” are analyzed by the financial verification computing apparatus 14. A variety of NLP techniques can optionally be used to process the transaction descriptions. Spacy, which is an open-source natural language processing library, is one such example.

In Step 415, transaction streams are identified from the transaction data. A transaction stream comprises more than one transaction in which each transaction has some common factor (or combination of factors) such as a description, issuer name, date, amount, etc. Transaction data may comprise individual transactions and transaction streams.

In an embodiment, in order to identify the transactions that qualify as a stream, the tokenized transactions are duplicated into two lists and then compared. The purpose of this duplication and comparison is to use both strings to identify transactions having one or more common factors. For example, transactions having similar names may comprise a transaction stream. To compare the transactions in the transaction data, a variety of data analytics tools can be used, including string comparison algorithms. The string comparison algorithm can be used to identify a level of similarity between transaction data. For example, Jaro-Winkler Distance algorithm, can allow finding similarities between two sets of strings based on the length of each string, the number of characters that are similar, and the positions of similar characters in each string. In an embodiment, transactions in the transaction data that meet or exceed a threshold of similarity using the string comparison algorithm may be considered a transaction stream. Other algorithms for determining similarity between transactions are also contemplated. The transactions that qualify as a transaction stream are identified or otherwise grouped for further analysis.

At step 420, each transaction stream is analyzed to determine if it is an income transaction stream. For example, all transactions having a similar source, such as a single employer, may comprise an income transaction stream. In an embodiment, transactions involving the deposit of a similar amount of money may be indicative of an income transaction stream. The periodicity of the transaction stream is another indicator of an income stream. The periodicity of the income stream is determined by the financial verification computing apparatus 14. The transactions that are identified as an income stream are grouped together. Statistical analysis is applied to the group of transactions comprising the income stream to determine the periodicity of when the user is paid. For example, the standard deviation of the duration between transactions could be used to determine the regularity of income.

At step 425, the financial verification computing apparatus 14 determines if the income stream is still active. In other words, is the user still employed and getting paid? In an embodiment, if the most recent transaction in the stream of transactions is less than 1.5 times the periodicity of the transactions, then the income stream is considered active. For example, if the periodicity of an income stream is determined to be bi-weekly (occurring every 14 days), then if the most recent transaction has occurred 21 days or less from the current date, then the income stream is considered active. If the most recent transaction occurred greater than 21 days before the current date, then the income stream would be considered inactive.

In step 430, the after-tax income is calculated by summing the active income streams for the user.

Returning to FIG. 3, at step 335, the financial verification computing apparatus 14 requests through the communication network 30 to the one or more user computing devices 12(1)-12(n) for the user's current annual income.

At step 340, the financial verification computing apparatus 14 requests through the communication network 30 to the one or more user computing devices 12(1)-12(n) for the user's employer name.

At step 345, the financial verification computing apparatus 14 requests through the communication network 30 to the one or more user computing devices 12(1)-12(n) for the user's zip code.

At step 350, the financial verification computing apparatus 14 requests through the communication network 30 to the one or more user computing devices 12(1)-12(n) for the user's start date when the user began receiving the current annual income listed in step 335.

In an embodiment, additional information may be received from the user, such as demographic information. Demographic information may include the number of dependents the user claims on income taxes.

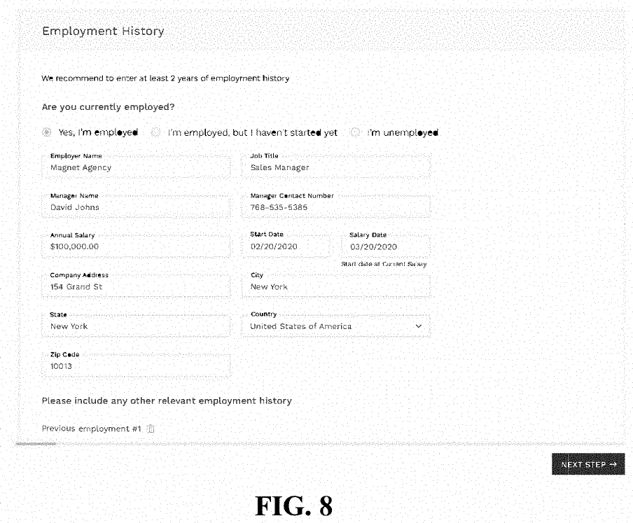

FIG. 8 is a diagram of an exemplary user interface for entering employment history information, including an employer name, an annual income, a start date, an end date, an address, a zip code, etc. for each employer. This exemplary diagram requests the user to enter current annual income, employer name, zip code, and start date for receiving the current annual income referenced in steps 335, 340, 345, and 350, respectively.

At step 355, the financial verification computing apparatus 14 determines the accuracy of the user stated income. To determine the accuracy of the user stated income, the financial verification computing apparatus 14 determines the estimated after-tax income on an annualized basis and then compares that amount to the income in the user's financial accounts to see if the two numbers match. To determine the after-tax income, the tax rate is determined by using the user's zip code and any demographic information related to taxes, such as deductions. If the start date at the current salary is lower than one year, then the after-tax salary of the income stream is annualized based on the median transaction amount and the periodicity. The estimated tax rate is applied to the user's stated gross income to determine the amount of taxes that are likely withheld. These estimated taxes are subtracted from the user's stated gross income to yield an estimated net income.

The estimated net income is then compared to the actual post-tax income as measured by the income streams in the user selected bank accounts.

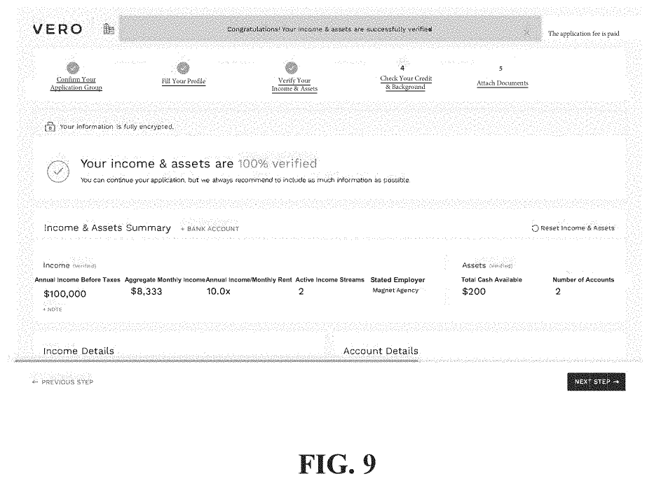

At step 360, the financial verification computing apparatus 14 determines if the user stated income is verified. In an embodiment, if the estimated post-tax income is higher than or equal to 90% of the actual post-tax income from the income streams, then the income is verified. If the estimated post-tax income is less than 90% of the actual post-tax income from the income streams, then the income is not verified. In an embodiment, an output display on the one or more user computing devices 12(1)-12(n) will indicate the percentage to which the income is verified. FIG. 9 is an exemplary diagram of a display to the user on the one or more user computing devices 12(1)-12(n), indicating that employment, income, and asset have been verified.

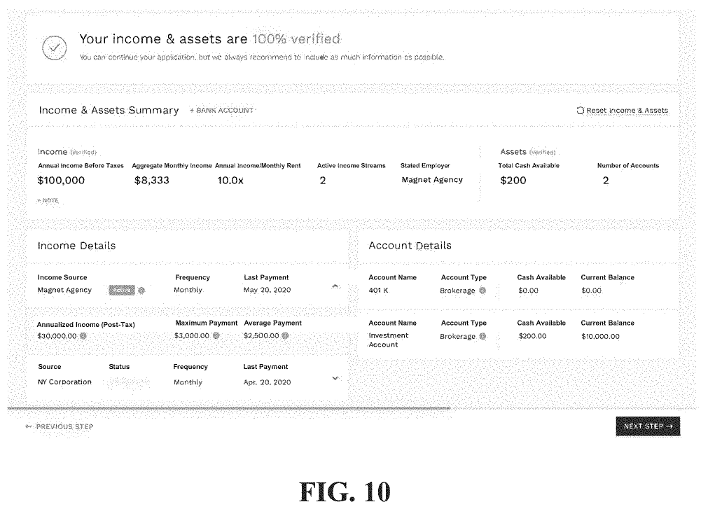

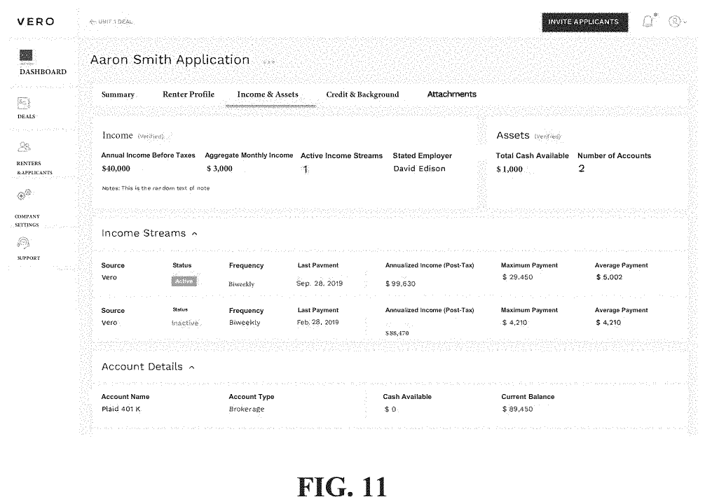

In an embodiment, FIG. 10 is a diagram of an exemplary user interface showing verified employment, income, and asset information, which is provided to the user (e.g., a prospective tenant). In another embodiment, FIG. 11 is a diagram of an exemplary user interface showing verified employment, income, and asset information, which is provided to a third party (e.g., a leasing manager).

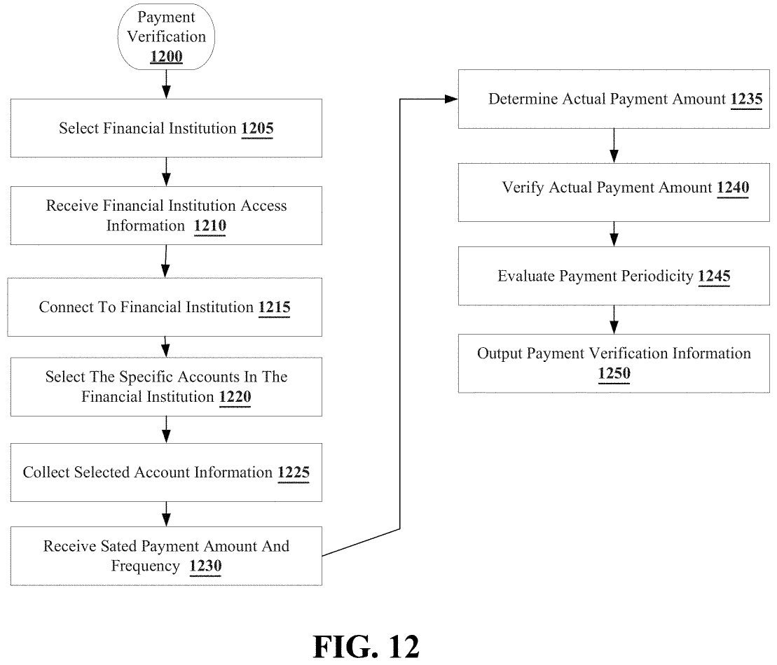

FIG. 12 discloses an exemplary method for payment verification. In an embodiment, a prospective tenant can verify past rent or mortgage payments to a landlord. The method begins at step 1200.

At step 1205, the financial verification computing apparatus 14 processes the received request to verify the user's payment history. As part of this process, the financial verification computing apparatus 14 sends to the one or more user computing devices 12(1)-12(n) a selection request to pick a financial institution in which payments are made. For example, the user may select a bank such as Bank of America.

In step 1210, the user is asked to enter the appropriate access information for the selected financial institution. For example, user identification and password may be needed to access the user's accounts at the financial institution. In some embodiments, the access information may comprise biometric data associated with the user, challenge questions with answers associated with the user, personal identification numbers (PINs), or other user access information that is needed to access the user's accounts at the selected financial institution.

In step 1215, the financial verification computing apparatus communicating through the communication network 30 connects to the selected financial institutions and uses the financial institution access information from the user to access the user's accounts. The financial institution may store account information on one or more data servers 16(1)-16(n). If the account information is correct, the financial verification computing apparatus 14 will now have access to the accounts to the user's account(s) on the selected financial institution. If the account information is incorrect, the financial verification computing apparatus 14 sends a message to the one or more user computing devices 12(1)-12(n), indicating that access to the financial institution failed. In an embodiment, the user is prompted to re-enter the user access information.

In an embodiment, the connection to the user's selected financial institution may be performed using Plaid. Plaid is an infrastructure layer that allows users to directly connect to their bank accounts.

The financial verification computing apparatus 14 aggregates the user's financial accounts at the financial institution and the financial verification computing apparatus 14 presents the list of financial accounts to the user at the one or more user computing devices 12(1)-12(n) accessed by the user. In an embodiment, the financial verification computing apparatus 14 can only access the financial accounts in “read-only” mode, i.e., no changes with respect to the financial accounts can be made, or no money can be withdrawn from these financial accounts.

At step 1220, the user selects the one or more accounts from which the payments were made. For example, the user may write monthly rent checks from a checking account. In another example, the user may pay the rent using two or more accounts.

In step 1225, the selected account information is received through the one or more user computing devices 12(1)-12(n) and communicated through the communication network 30 to financial verification computing apparatus 14. The financial verification computing apparatus 14 sends a request to the user's financial institution via communication network 30 to retrieve transaction data associated with the one or more selected accounts. The financial institution obtains this information from one or more data servers 16(1)-16(n) and provides this information to the financial verification computing apparatus 14.

The transaction data comprises the deposits, withdrawals, fees, interests, comments, and other transactions associated with the selected account. This transaction data comprises financial information about the user, including, in an embodiment, payment information.

In step 1230, the financial verification computing apparatus 14 requests through the communication network 30 to the one or more user computing devices 12(1)-12(n) for the user's stated payment information, e.g., amount and frequency.

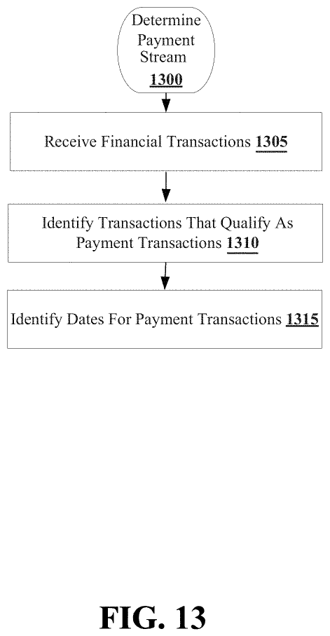

At step 1235, the financial verification computing apparatus 14 determines the payment amount from the user's financial accounts. This process is described in more detail with respect to FIG. 13.

The process of determining payment amount from the transaction data begins at step 1300. At step 1305, the transaction data from each selected account are received. Then, at step 1310, the transactions that qualify as a payment are identified. To do this, in an embodiment, the financial verification computing apparatus 14 identifies all transactions where the transaction amount is within 90%-110% of the user stated rent amount.

At step 1315, the dates for each identified transaction are also determined.

Returning to FIG. 12, at step 1240, the financial verification computing apparatus 14 verifies the payment amount by comparing the actual payment amount identified in step 1310 with the stated payment amount. In an embodiment, if the actual payment amount equals the stated payment amount, then the payment is verified.

In step 1245, the payment periodicity is verified. In an embodiment, the financial verification computing apparatus 14 evaluates the date of the actual payments against a payment due date. In an embodiment, the payment due date may be the user entered payment frequency (e.g., the first of each month) from step 1230. In this example, if payments are made before the first of the month, then the payment is determined to be “paid early.” In an embodiment, if payments are made between the first of the month and five days after the first of the month, then the payment is determined to be “paid on time.” In an embodiment, if payments are made more than five days after the first of the month but less than or equal to ten days after the first of the month, then the payment is determined to be “paid somewhat late.” In an embodiment, if payments are made more than ten days after the first of the month, then the payment is determined to be “paid very late.”

At step 1250, the financial verification computing apparatus 14 outputs to the one or more user computing devices 12(1)-12(n) a result of the payment verification. In an embodiment, the verification result can be output in a form of a graph.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, is not intended to limit the claimed processes to any order except as may be specified in the claims. Accordingly, the invention is limited only by the following claims and equivalents thereto.

What is claimed:

1. A method for verifying a stated income, the method comprising:
receiving, by a financial verification computing apparatus, financial information;
determining, by the financial verification computing apparatus, an income stream from the financial information by natural language processing;
receiving, by the financial verification computing apparatus, the stated income and income information;
determining, by the financial verification computing apparatus, a calculated income using the income stream and income information;
determining, by the financial verification computing apparatus, a verification result using the calculated income; and
outputting the verification result.

2. The method as set forth in claim 1, wherein the income information comprises a zip code, an employer name, and a start date when the stated income began.

3. The method as set forth in claim 1, wherein the step of determining the income stream from the financial information further comprising, collecting, by the financial verification computing apparatus, financial transactions.

4. The method as set forth in claim 3, further comprising, tokenizing, by the financial verification computing apparatus, a name of each of the financial transactions.

5. The method as set forth in claim 4, further comprising, identifying, by the financial verification computing apparatus, the names of each of the financial transactions that are similar through a string comparison algorithm.

6. The method as set forth in claim 5, wherein the income stream comprises the financial transactions with similar names.

7. The method as set forth in claim 6, further comprising, determining, by the financial verification computing apparatus, a periodicity of the income stream.

8. The method as set forth in claim 7, further comprising, determining, by the financial verification computing apparatus, an active status for the income stream based on the periodicity and a most recent financial transaction in the income stream.

9. The method as set forth in claim 1, further comprising, requesting, by the financial verification computing apparatus, confirmation that the calculated income is accurate.

10. The method as set forth in claim 2, wherein the step of determining the calculated income further comprises calculating, by the financial verification computing apparatus, a tax amount based on the zip code and subtracting the tax amount from the income stream.

11. A method for payment verification, the method comprising:
receiving, by a financial verification computing apparatus, financial information from one or more financial institutions;
receiving, by the financial verification computing apparatus, first payment information from a user;
determining, by the financial verification computing apparatus, second payment information from the financial information by natural language processing;
determining, by the financial verification computing apparatus, a verification result by comparing the first payment information and the second payment information; and
outputting the verification result.

12. The method as set forth in claim 11, wherein the first payment information comprises a payment amount and a payment due date.

13. The method as set forth in claim 11, wherein the step of determining the second payment information from the financial information further comprising, collecting, by the financial verification computing apparatus, a plurality of financial transactions.

14. The method as set forth in claim 13, further comprising, identifying, by the financial verification computing apparatus, one or more financial transactions from the plurality of financial transactions, wherein each of the one or more financial transactions has a transaction amount within 90%-110% of the payment amount in the first payment information.

15. The method as set forth in claim 14, further comprising, identifying, by the financial verification computing apparatus, a date for each of the one or more financial transactions.

16. The method as set forth in claim 15, wherein the verification result comprises,
determining a payment time based on comparing the date for each of the one or more financial transactions with the payment due date.

17. The method as set forth in claim 16, wherein the payment time comprises paid early, paid on time, paid somewhat late, or paid very late.

18. The method as set forth in claim 11, wherein the verification result comprises a graph.
